(19) United States
(12) Patent Application Publication
(10) Pub. No.: US 2026/0105047 A1
(43) Pub. Date: Apr. 16, 2026

(54) DATA QUERY METHOD AND RELATED DEVICE

(71) Applicant: Beijing Volcano Engine Technology Co., Ltd., Haidian District (CN)

(72) Inventors: Yuxing HAN, Beijing (CN); Lixiang CHEN, Beijing (CN); Yu CHEN, Beijing (CN)

(21) Appl. No.: 19/357,297

(22) Filed: Oct. 14, 2025

(30) Foreign Application Priority Data
Oct. 16, 2024 (CN) 202411448430.X

(51) Int. Cl. G06F 16/2452; G06F 16/28

(52) U.S. Cl. CPC G06F 16/2452; G06F 16/285

(57) ABSTRACT

The present disclosure provides a data query method and a related device. The method includes: receiving a query request for target data, where the query request is used to request to query the target data in a target database; matching the query request with a plurality of candidate query categories; in response to the query request matching a target query category in the plurality of candidate query categories, determining at least one target database parameter of the target database, according to the target query category; adjusting at least one database parameter of the target database, based on the at least one target database parameter; and querying the target data in the target database after parameter adjustment, based on the query request.

### CROSS-REFERENCE TO RELATED APPLICATION

This application claims priority to Chinese Application No. 202411448430.X filed on October 16, 2024, the disclosure of which is incorporated herein by reference in its entirety.

### FIELD

The present disclosure relates to the field of computer technologies, and in particular, to a data query method and a related device.

### BACKGROUND

In the field of computer technologies, a database is usually used to store data, and data may be queried from the database based on a query request. Query success rate is one of important evaluation indicators for a database.

### SUMMARY

The present disclosure provides a data query method and a related device.

In a first aspect, the present disclosure provides a data query method, including:

receiving a query request for target data, where the query request is used to request to query the target data in a target database;

matching the query request with a plurality of candidate query categories;

in response to the query request matching a target query category in the plurality of candidate query categories, determining at least one target database parameter of the target database, according to the target query category;

adjusting at least one database parameter of the target database, based on the at least one target database parameter; and

querying the target data in the target database after parameter adjustment, based on the query request.

In a second aspect, the present disclosure provides a data query apparatus, including:

a receiving module configured to: receive a query request for target data, where the query request is used to request to query the target data in a target database;

a matching module configured to: match the query request with a plurality of candidate query categories;

a determining module configured to: in response to the query request matching a target query category in the plurality of candidate query categories, determine at least one target database parameter of the target database, according to the target query category;

an adjusting module configured to: adjust at least one database parameter of the target database, based on the at least one target database parameter; and

a querying module configured to: query the target data in the target database after parameter adjustment, based on the query request.

In a third aspect, the present disclosure provides a computer device, including one or more processors, a memory, and one or more programs, where the one or more programs are stored in the memory and executed by the one or more processors, and the programs include instructions for executing the method according to the first aspect.

In a fourth aspect, the present disclosure provides a non-volatile computer-readable storage medium including a computer program, where the computer program, when executed by one or more processors, causes the processors to perform the method according to the first aspect.

In a fifth aspect, the present disclosure provides a computer program product, including computer program instructions, where the computer program instructions, when running on a computer, cause the computer to perform the method according to the first aspect.

### BRIEF DESCRIPTION OF THE DRAWINGS

In order to illustrate the technical solutions in the present disclosure or in the related art more clearly, the following will briefly introduce the drawings that need to be used in the description of the embodiments or the related art. Obviously, the drawings in the following description are only some embodiments of the present disclosure, and for those of ordinary skill in the art, other drawings may also be obtained according to these drawings without creative effort.

FIG. 1 is a schematic diagram of an exemplary system provided by an embodiment of the present disclosure.

FIG. 2A is a schematic flowchart of an exemplary method provided by an embodiment of the present disclosure.

FIG. 2B is a schematic flowchart of determining a database parameter according to an embodiment of the present disclosure.

FIG. 2C is another schematic flowchart of determining a database parameter according to an embodiment of the present disclosure.

FIG. 2D is yet another schematic flowchart of determining a database parameter according to an embodiment of the present disclosure.

FIG. 2E is a schematic flowchart of determining a query category according to an embodiment of the present disclosure.

FIG. 3 is another schematic flowchart of an exemplary method provided by an embodiment of the present disclosure.

FIG. 4 is a schematic diagram of an exemplary apparatus provided by an embodiment of the present disclosure.

FIG. 5 is a schematic diagram of a hardware structure of an exemplary computer device provided by an embodiment of the present disclosure.

### DETAILED DESCRIPTION OF EMBODIMENTS

In order to make the objectives, technical solutions, and advantages of the present disclosure clearer, the present disclosure will be further described in detail below with reference to the specific embodiments and the drawings.

It should be noted that, unless otherwise defined, the technical or scientific terms used in the embodiments of the present disclosure should be given ordinary meanings as understood by those of ordinary skill in the art to which the present disclosure belongs. The terms such as "first" and "second" used in the embodiments of the present disclosure do not denote any order, number, or importance, but are only used to distinguish one component from another. The terms "include/comprise" or "include/comprise" and the like mean that an element or object appearing in front of the word covers an element or object and its equivalent listed after the word, and does not exclude other elements or objects. The terms "connect" or "connected" and the like are not limited to physical or mechanical connection, but may include electrical connection, whether direct or indirect. "Up", "down", "left", "right", etc. are only used to indicate a relative positional relationship, and when the absolute position of the described object changes, the relative positional relationship may also change accordingly.

It can be understood that before using the technical solutions of the embodiments of the present disclosure, the user will be informed of the type, scope of use, use scene, etc. of the involved personal information in an appropriate manner, and the authorization of the user will be obtained.

For example, in response to receiving an active request from the user, the prompt information is sent to the user to clearly prompt the user that the operation requested to be performed will require the acquisition and use of the user's personal information. Therefore, the user can independently choose whether to provide personal information to software or hardware such as an electronic device, an application, a server, or a storage medium that performs the operations of the technical solutions of the present disclosure according to the prompt information.

As an optional but not limiting implementation, the manner of sending the prompt information to the user in response to receiving the active request from the user may be, for example, a pop-up window, in which the prompt information may be presented in a text form. In addition, the pop-up window may also carry a selection control for the user to select "agree" or "disagree" to provide personal information to the electronic device.

It can be understood that the above process of notifying and acquiring user authorization is only illustrative and does not constitute a limitation on the implementations of the present disclosure. Other methods that meet relevant laws and regulations may also be applied to the implementations of the present disclosure.

The inventors of the present disclosure find that in the related art, the query success rate is at a relatively high level, but there is still room for improvement.

According to the data query method and related device provided by embodiments of the present disclosure, in the case where the query request matches the target query category when the query request is received, the database parameter of the target database may be adjusted based on the target database parameter corresponding to the target query category, and then data is queried based on the target database after parameter adjustment, so that the query success rate can be improved.

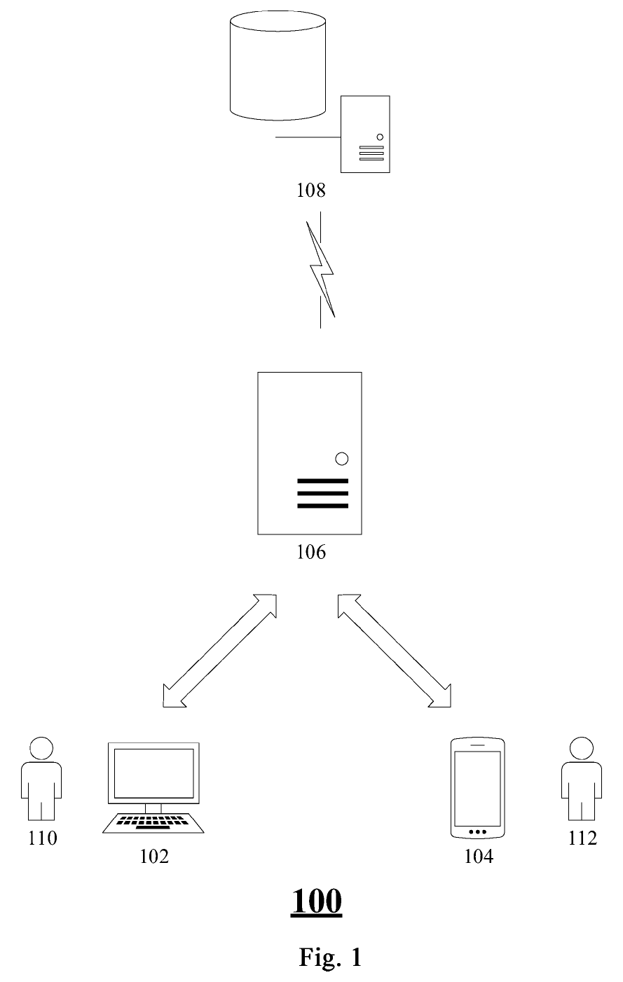

FIG. 1 is a schematic diagram of an exemplary system 100 provided by an embodiment of the present disclosure.

As shown in FIG. 1, the system 100 may include a terminal device 102, a terminal device 104, a server 106, and a database server 108. A medium (for example, a network) that provides a communication link may be included between the terminal device 102 and the terminal device 104 and between the server 106 and the database server 108. The network may include various connection types, such as wired and wireless communication links or optical fiber cables, etc.

Exemplarily, various applications (APPs) may be installed on the terminal device 104, such as a life service application, a collaborative office application, a video conference application, a reading application, a video application, a social application, a payment application, a web browser, an instant messaging application, and the like.

The terminal device 102 and the terminal device 104 here may be hardware or software. When the terminal device 102 and the terminal device 104 are hardware, they may be various electronic devices with display screens, including but not limited to smart phones, tablet computers, e-book readers, MP3 players, laptop computers, desktop computers, etc. When the terminal device 102 and the terminal device 104 are software, they may be installed in the above-mentioned electronic devices. It may be implemented as multiple pieces of software or software modules (for example, to provide distributed services), or may be implemented as a single piece of software or a software module. There is no specific limitation here.

The server 106 may be a server that provides various services, for example, a background server that provides support for various applications displayed on the terminal devices 102 and 104. The database server 108 may also be a database server that provides various services. It can be understood that in the case where the server 106 can implement the related functions of the database server 108, the database server 108 may not be set in the system 100.

The server 106 and the database server 108 here may also be hardware or software. When they are hardware, they may be implemented as a distributed server cluster composed of multiple servers, or may be implemented as a single server. When they are software, they may be implemented as multiple pieces of software or software modules (for example, to provide distributed services), or may be implemented as a single piece of software or a software module. There is no specific limitation here.

It should be understood that the number of terminal devices, users, servers, and database servers in FIG. 1 is only illustrative. According to the implementation requirements, any number of terminal devices, users, servers, and database servers may be provided.

As an exemplary scenario, one or more database servers 108 may constitute a database for storing data and searching for corresponding data based on a query request and then returning the data when the query request is received, and so on. For example, the user 112 may use any application of the terminal device 104 to request a service, and the service needs to acquire corresponding data to return to the terminal device 104. At this time, a query request may be generated based on the request of the user 112 and sent to the database for data query. The database queries the corresponding data based on the query request and returns it to the terminal device 104.

In the related art, the user 110 (for example, a database operation and maintenance personnel) may remotely debug the database parameter through the terminal device 102, so that the query success rate can be as high as possible. However, the efficiency of manual adjustment is low.

In the related art, in an online cluster of a database (for example, a cluster composed of multiple database servers 108), although the proportion of the number of failed queries is usually small (generally in the range of 0% to 5%), even so few failed queries have a great impact on the service level agreement (SLA) and the user experience. It may cause the user to encounter delay, interruption, or error feedback when performing a query operation, thereby reducing the user's trust and satisfaction with the database system. At the same time, for business scenarios with strict requirements for data timeliness and accuracy, a failed query may trigger a series of chain reactions and affect the smooth progress of the entire business process.

The inventors of the present disclosure find that, firstly, for a failed query of a database online cluster, there is a considerable part of the reasons for the query failure mainly in terms of excessive memory usage, excessive query time, and excessive number of query rows/bytes. Therefore, if relevant parameters can be reasonably set, the probability of successful query can be improved to a certain extent. However, if these relevant parameters are set globally (for example, corresponding settings are made for each database parameter), the overall performance of the database cluster is likely to be dragged down. Secondly, some failed queries have almost the same Structured Query Language (abbreviated as SQL) structure and semantics, and will repeatedly fail to be executed for the same reason within a long period of time. This means that for this type of failed query with a specific pattern, targeted analysis and optimization may be performed.

In view of this, an embodiment of the present disclosure provides a data query method to solve or partially solve the above problems.

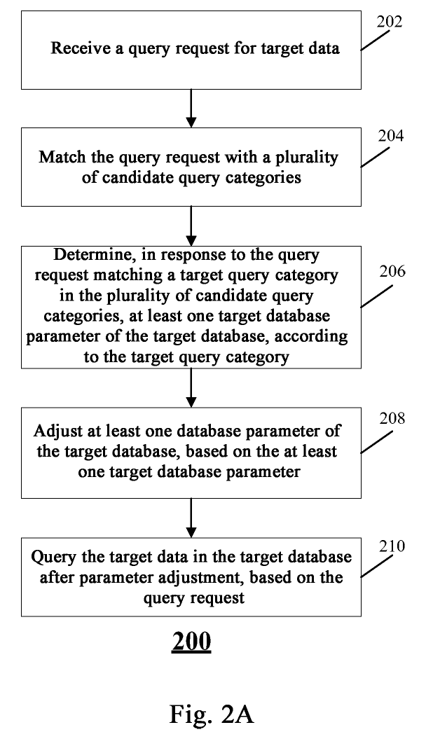

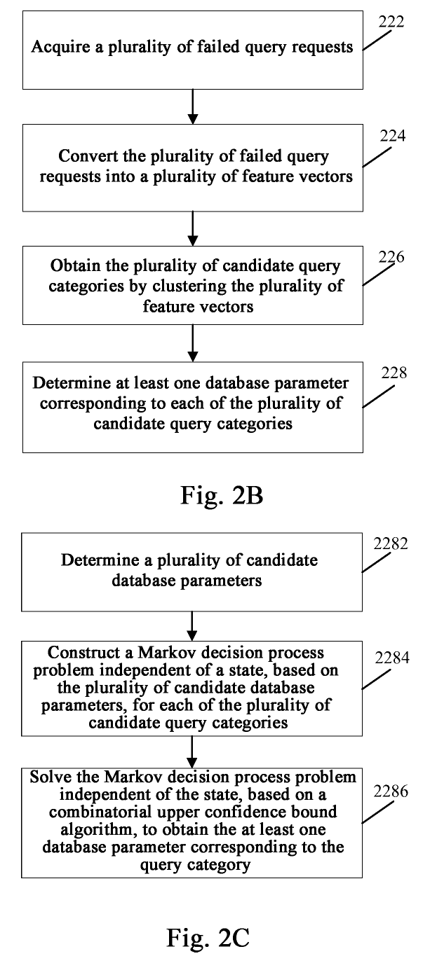

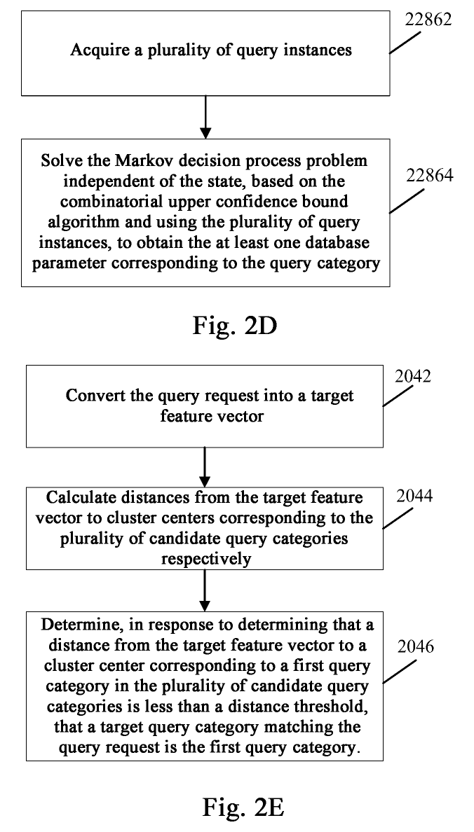

FIG. 2A is a schematic flowchart of an exemplary method 200 provided by an embodiment of the present disclosure. The method 200 may be used for data query based on a query request. Optionally, the method 200 may be implemented by the server 106 in FIG. 1, or may be implemented by the system 100 in FIG. 1. As shown in FIG. 2A, the method 200 further includes the following steps.

In step 202, a query request for target data may be received, where the query request is used to request to query the target data in a target database. Optionally, the query request may be, for example, a Structured Query Language (abbreviated as SQL) command, which is used to request to perform a corresponding query operation.

In step 204, the query request may be matched with a plurality of candidate query categories.

Each candidate query category may correspond to a type of query, for example, a query category with consistent SQL structure and semantics.

Optionally, the candidate query category may indicate that at least one database parameter corresponding to a query request matching the candidate query category being adjustable. In this way, when the query request matches any candidate query category, the target database parameter obtained based on the candidate query category may be used to adjust the database parameter of the target database in real time.

Optionally, the candidate query category may indicate that a query success rate of a query request matching the candidate query category being lower than a success rate threshold. In this way, when the query request matches any candidate query category, the target database parameter obtained based on the candidate query category may be used to adjust the database parameter of the target database in real time, and the query success rate may be improved.

In some embodiments, the candidate query category may simultaneously indicate that the at least one database parameter corresponding to the query request matching the candidate query category being adjustable and the query success rate of the query request matching the candidate query category being lower than the success rate threshold, thereby achieving a better effect.

It can be understood that in some embodiments, the method 200 may further include steps for generating the candidate query category. As shown in FIG. 2B, the method 200 may further include the following steps.

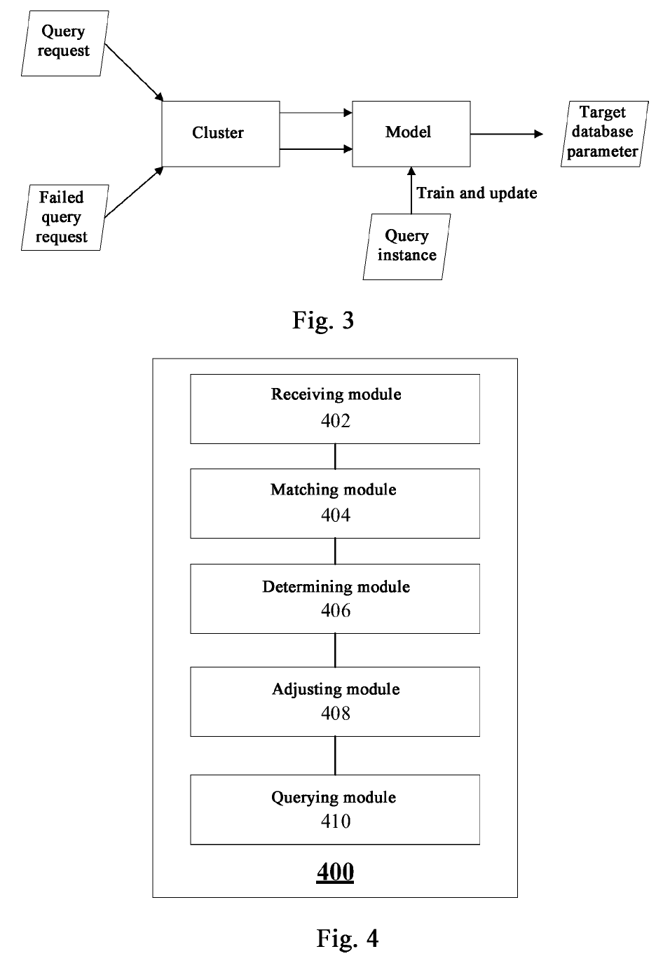

In step 222, as shown in FIG. 3, a plurality of failed query requests may be acquired.

Exemplarily, the historical failed query requests may be acquired in a low load period of each day, for example, a period from 0:00 to 6:00.

Since there are some failed queries that cannot be adjusted (for example, a gateway will truncate an ultra-long SQL, and some failed SQLs are KILL statements that cannot be adjusted, etc.), the failed query requests may be filtered with a simple rule. Therefore, optionally, these failed query requests may be filtered to obtain the failed query requests for which a parameter of a database can be adjusted (that is, the query success rate may be improved by adjusting the database parameter, or the database parameter related to the failed query request is adjustable). Optionally, the filtering condition may include that the SQL of the query is not truncated by the gateway, and the case of query failure may be reproduced, and so on. Through such filtering operation, some SQLs for which a parameter cannot be adjusted may be filtered out. In this process, there may also be some query requests that cannot reproduce the execution failure stably in the current environment. These query requests may be caused by excessive load in a specific period, and in the low load period, since the execution failure cannot be reproduced, the parameter cannot be adjusted, and therefore, these query requests may also be filtered out.

In step 224, the plurality of failed query requests are converted into a plurality of feature vectors.

In this step, these failed query requests may be converted into feature vectors. It can be understood that there are many feature methods, which will not be specifically limited here.

In step 226, as shown in FIG. 3, the plurality of candidate query categories may be obtained by clustering the plurality of feature vectors.

In this step, the plurality of candidate query categories are obtained through clustering by performing a clustering operation on the plurality of feature vectors, which are used as query request templates. Such a clustering process can group query requests with similar features into a category, thereby providing a basis for subsequent parameter adjustment work.

In some embodiments, a DBSCAN (Density-Based Spatial Clustering of Applications with Noise) method may be used for clustering. DBSCAN is a density-based clustering algorithm, which can divide areas with sufficiently high density into clusters and recognize noise points. Therefore, the method can be used to perform clustering operation and discard the noise points at the same time.

As shown in FIG. 2B, further, in step 228, at least one database parameter corresponding to each candidate query category is determined, and the database parameter is used to adjust the parameter of the target database when the query request matches the candidate query category.

The inventors of the present disclosure find that those parameters that are closely related to whether the query fails can be regarded as Boolean parameters to a great extent (the value is only 0 or 1), such as whether to turn on or off the optimization of a specific parameter. Therefore, a simple Markov decision process problem may be constructed and solved for each candidate query category to determine at least one database parameter corresponding to each candidate query category. By determining the corresponding database parameter for each candidate query category, the optimal parameter combination suitable for this type of query request can be found more accurately.

Therefore, in some embodiments, as shown in FIG. 2C, step 228 of determining the at least one database parameter corresponding to each candidate query category may further include the following steps.

In step 2282, a plurality of candidate database parameters are determined.

In this step, a plurality of database parameters may be selected as the candidate database parameters. Optionally, the database parameters that have a great impact on the query success rate may be selected as the candidate database parameters. For example, a parameter closely related to query success may be simply regarded as a Boolean parameter (the value is only 0 or 1). For example, the parameter “max_bytes before_external_group_by” controls whether to enable disk dumping for “group by”. The setting of such a Boolean parameter can clearly reflect the influence of two different choices of the parameter on a query result.

In step 2284, for each candidate query category, a Markov decision process problem independent of a state is constructed based on the plurality of candidate database parameters.

In the process of parameter adjustment, a plurality of parameters may be turned on at the same time in each step (that is, the plurality of parameters are adjusted at the same time). Therefore, the adjusted parameters may also be considered as combined parameters. This means that a plurality of parameters related to query success may be adjusted at the same time to find the optimal parameter combination. By considering different values of the plurality of parameters at the same time, the parameter space can be explored more comprehensively, and the possibility of finding the optimal parameter combination can be improved.

The execution result of the query request may be quantified by a reward. When the query is successfully executed, the reward R=1; while when the query fails to be executed, the reward R=0. Such a simple reward setting can intuitively reflect the query result, which is convenient for evaluation and decision-making in the process of parameter adjustment.

Therefore, based on the above characteristics, a Markov decision process problem independent of a state may be constructed, and a combined parameter corresponding to the candidate query category may be obtained by solving the problem.

In a traditional Markov decision process (MDP) problem, a decision-maker takes an action in each state and transfers to the next state according to environmental transition probabilities and a reward function, and obtain a reward at the same time.

The problem constructed in this step simplifies this Markov decision process problem. It is assumed that there is no state (or the state space is a single state), or the transition between states does not affect the distribution of rewards. In the Markov decision process problem independent of the state, it is only necessary to select an action (for example, select a certain parameter) in each round, and then obtain a reward according to the reward distribution of the action. The core of this problem is to balance the relationship between exploration (trying new or unknown actions to better understand their reward distribution) and exploitation (selecting actions that currently seem optimal to maximize the reward).

Therefore, the objective of parameter adjustment is to recommend a group of parameters for the query request, so that the query request has the highest possible probability of successful execution. By constantly trying different parameter combinations, observing the execution results of the query, and adjusting according to these results, a group of parameters that are most suitable for the candidate query category can be gradually found, thereby improving the success rate of the query.

In this embodiment, all possible parameter combinations are not enumerated, and the failed query request is simply executed with the parameters, because the inventors of the present disclosure find following things.

1. In practical situations, due to the complexity of the online environment, including the influence of various factors such as network conditions, server load, and dynamic changes in data distribution, the execution result of the query request has a certain degree of uncertainty. Whether the query is successful or not is not a certain event. Even a very good parameter combination has a very small probability of execution failure in a complex online environment; a very poor parameter combination also has a very small probability of execution success. Therefore, whether this parameter combination is recommended cannot be determined based on the result of one execution.

2. The scale of enumerating all parameter combinations is 2N-1, where N is the number of parameters. As the number of parameters increases, the number of possible parameter combinations increases exponentially. If all parameter combinations are enumerated and executed multiple times, the cost is very high.

In order to solve the above problems, a Combinatorial Upper Confidence Bound (abbreviated as CUCB) algorithm may be used to solve the above Markov decision process problem independent of the state.

Therefore, as shown in FIG. 2C, in step 2286, the Markov decision process problem independent of the state may be solved based on the combinatorial upper confidence bound algorithm to obtain at least one database parameter corresponding to the query category.

The CUCB algorithm may repeatedly explore the execution results of the combined actions, so as to obtain the mean and variance of each basic action, and then infer the upper confidence interval (UCB). In this process, the algorithm will keep trying different parameter combinations, collecting execution results, and updating the evaluation of each parameter combination according to these results. By repeating this process many times, the algorithm can gradually and accurately estimate the performance of each parameter combination. Finally, after several rounds of exploration, the combined action with the largest UCB is taken as the recommended parameter.

In some embodiments, as shown in FIG. 2D, solving the Markov decision process problem independent of the state based on the combinatorial upper confidence bound algorithm to obtain at least one database parameter corresponding to the query category includes:

in step 22862, as shown in FIG. 3, a plurality of query instances may be acquired,

where the query instance includes a historical query request (including a successful query request and a failed query request) and corresponding database parameters.

in step 22864, the Markov decision process problem independent of the state is solved based on the combinatorial upper confidence bound algorithm and using the plurality of query instances to obtain at least one database parameter corresponding to the query category.

In this way, the query instance is used to solve the Markov decision process problem independent of the state based on the combinatorial upper confidence bound algorithm. After several rounds (for example, 100 rounds), a group of better parameter combinations may be obtained and used as the database parameter corresponding to the candidate query category.

As shown in FIG. 3, in step 204, when the user 114 sends the query request, the clustering algorithm will first identify whether the query request can match any candidate query category, and perform different processing according to actual conditions.

In some embodiments, as shown in FIG. 2E, matching the query request with the plurality of candidate query categories includes:

in step 2042, converting the query request into a target feature vector;

in step 2044, calculating distances from the target feature vector to cluster centers corresponding to the plurality of candidate query category respectively; and

in step 2046, in response to determining that a distance from the target feature vector to a cluster center corresponding to a first query category in the plurality of candidate query categories is less than a distance threshold (for example, an EPS parameter of DBSCAN), determining that a target query category matching the query request is the first query category.

In some embodiments, matching the query request with the plurality of candidate query categories further includes: in response to determining that each distance from the target feature vector to each cluster center corresponding to each candidate query category is not less than the distance threshold, determining that the query request does not match each of the plurality of candidate query categories.

In this way, each time the inference is performed, only the characterization of the SQL and the distance calculation of about 20 points need to be completed, and this calculation manner makes the calculation cost relatively low and the calculation efficiency relatively high.

In some embodiments, the method 200 may further include: in response to the query request not matching each of the plurality of candidate query categories, querying the target data in the target database, based on the query request. Optionally, in the DBSCAN clustering algorithm, the query request that cannot be matched will be classified as a noise point. If the query request cannot match any candidate query category, it is likely to be a successful query or a query that does not meet the filtering condition. In this case, the parameter adjustment operation may not be performed on the database, but data is directly queried in the target database based on the query request.

In some other embodiments, as shown in FIG. 2A, in step 206, in response to the query request matching the target query category in the plurality of candidate query categories, at least one target database parameter of the target database may be determined according to the target query category.

In this step, if the query request matches the target query category in the plurality of candidate query categories, a group of target database parameters corresponding to the matched target query category that have a high probability of successful execution may be determined. Such a parameter recommendation manner can fully utilize the existing parameter adjustment result, improve the execution success rate of a new query, and avoid the huge calculation cost caused by independent parameter adjustment for each new query.

In some embodiments, the at least one target database parameter includes a hardware parameter of the target database. For example, a parameter of a hardware resource of the database server 108, such as a parameter of performance and capacity of a central processing unit (CPU), a memory (RAM), a magnetic disk, etc. In this way, the database may be adjusted to a state where the query is more likely to succeed.

In step 208, at least one database parameter of the target database may be adjusted based on the at least one target database parameter.

In this step, the determined target database parameter corresponding to the target query category may be used to adjust the database parameter corresponding to the target database, so that the query success rate can be improved when the target database executes the query request.

In step 210, the target data may be queried in the target database after parameter adjustment, based on the query request.

In this way, when the target data is queried in the target database after parameter adjustment based on the query request, the query success rate can be significantly improved compared with the target database without parameter adjustment.

It can be understood that in the embodiments of the present disclosure, the clustering method identifies a query request with "a risk of execution failure". It should be clear that these identified query requests may still succeed without parameter adjustment of the database. On the whole, the proportion of query requests that will be identified as having a risk of failure in all query requests is very small, that is, the proportion of query requests that need to be executed with parameters is very small. Therefore, even if the process of clustering and matching the query category is added, its impact on the overall query performance is relatively small. In some embodiments, if it is desired to reduce the proportion of queries with parameters, the EPS parameter of the clustering, that is, the binary classification query index, may be lowered. Through such operations, the determination of a failed query may be made more conservative, and the impact on the overall query performance is smaller.

It should be noted that the method of the embodiment of the present disclosure may be executed by a single device, such as a computer or a server. The method of this embodiment may also be applied to a distributed scenario, which is completed by a plurality of devices in cooperation. In this distributed scenario, one of the plurality of devices may only execute one or more steps of the method of the embodiment of the present disclosure, and the plurality of devices interact with each other to complete the method.

It should be noted that some embodiments of the present disclosure are described above. Other embodiments are within the scope of the appended claims. In some cases, actions or steps recited in the claims may be performed in a different order from those in the above embodiments and still achieve desired results. In addition, the processes depicted in the drawings do not necessarily require the specific order or continuous order shown to achieve the desired results. In some implementations, multitasking and parallel processing may also be possible or advantageous.

An embodiment of the present disclosure further provides a data query apparatus. FIG. 4 is a schematic diagram of an exemplary apparatus 400 provided by an embodiment of the present disclosure. As shown in FIG. 4, the apparatus 400 may be used to implement the method 200, and may further include the following modules:

a receiving module 402 configured to: receive a query request for target data, where the query request is used to request to query the target data in a target database;

a matching module 404 configured to: match the query request with a plurality of candidate query categories;

a determining module 406 configured to: in response to the query request matching a target query category in the plurality of candidate query categories, determine at least one target database parameter of the target database, according to the target query category;

an adjusting module 408 configured to: adjust at least one database parameter of the target database, based on the at least one target database parameter; and

a querying module 410 configured to: query the target data in the target database after parameter adjustment, based on the query request.

In some embodiments, the querying module 410 is configured to: in response to the query request not matching each of the plurality of candidate query categories, query the target data in the target database based on the query request.

In some embodiments, the apparatus 400 further includes a parameter determining module configured to:

acquire a plurality of failed query requests;

convert the plurality of failed query requests into a plurality of feature vectors;

obtain the plurality of candidate query categories by clustering the plurality of feature vectors; and

determine at least one database parameter corresponding to each candidate query category.

In some embodiments, the parameter determining module is configured to:

determine a plurality of candidate database parameters;

construct a Markov decision process problem independent of a state based on the plurality of candidate database parameters for each candidate query category; and

solve the Markov decision process problem independent of the state based on a combinatorial upper confidence bound algorithm to obtain at least one database parameter corresponding to the query category.

In some embodiments, the parameter determining module is configured to:

acquire a plurality of query instances; and

solve the Markov decision process problem independent of the state based on the combinatorial upper confidence bound algorithm and using the plurality of query instances to obtain at least one database parameter corresponding to the query category.

In some embodiments, the matching module 404 is configured to:

convert the query request into a target feature vector;

calculate distances from the target feature vector to cluster centers corresponding to the plurality of candidate query category respectively; and

in response to determining that a distance from the target feature vector to a cluster center corresponding to a first query category in the plurality of candidate query categories is less than a distance threshold, determine that a target query category matching the query request is the first query category.

In some embodiments, the matching module 404 is configured to: in response to determining that each distance from the target feature vector to each cluster center corresponding to each candidate query category is not less than the distance threshold, determine that the query request does not match each of the plurality of candidate query categories.

In some embodiments, the candidate query category indicates at least one of the following:

at least one database parameter corresponding to a query request matching the candidate query category being adjustable; and

a query success rate of a query request matching the candidate query category being lower than a success rate threshold.

In some embodiments, the at least one target database parameter includes a hardware parameter of the target database.

For the convenience of description, the above apparatus is described by dividing it into various modules according to functions. Certainly, when implementing the present disclosure, the functions of the modules may be implemented in the same or multiple pieces of software and/or hardware.

The apparatus of the above embodiments is used to implement the corresponding method 200 in any of the foregoing embodiments, and has beneficial effects of the corresponding method embodiments, which will not be repeated here.

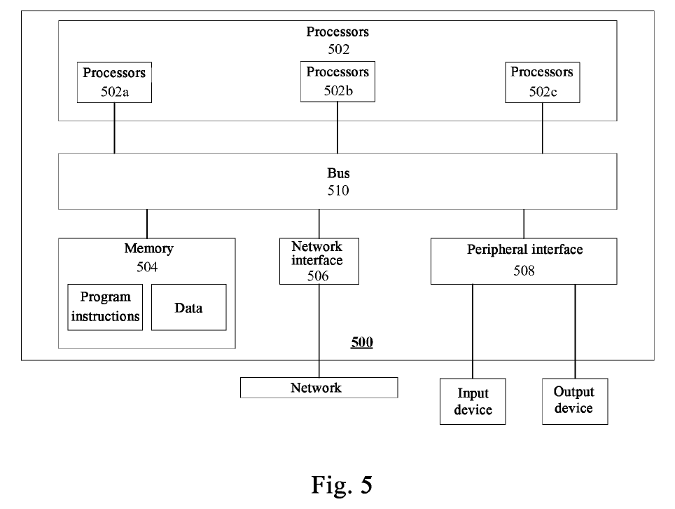

An embodiment of the present disclosure further provides a computer device for implementing the above method 200. FIG. 5 is a schematic diagram of a hardware structure of an exemplary computer device 500 provided by an embodiment of the present disclosure. The computer device 500 may be used to implement the server 106 in FIG. 1, or may be used to implement the terminal devices 102 and 104 in FIG. 1. In some scenarios, the computer device 500 may also be used to implement the database server 108 in FIG. 1.

As shown in FIG. 5, the computer device 500 may include a processor 502, a memory 504, a network module 506, a peripheral interface 508, and a bus 510. The processor 502, the memory 504, the network module 506, and the peripheral interface 508 implement communication connection between each other inside the computer device 500 through the bus 510.

The processor 502 may be a central processing unit (Central Processing Unit, CPU), an image processor, a neural network processor (NPU), a microcontroller (MCU), a programmable logic device, a digital signal processor (DSP), an application specific integrated circuit (Application Specific Integrated Circuit, ASIC), or one or more integrated circuits. The processor 502 may be configured to perform functions related to the technologies described in the present disclosure. In some embodiments, the processor 502 may further include multiple processors integrated into a single logical component. For example, as shown in FIG. 5, the processor 502 may include multiple processors 502a, 502b, and 502c.

The memory 504 may be configured to store data (for example, instructions, computer code, etc.). As shown in FIG. 5, the data stored in the memory 504 may include program instructions (for example, program instructions for implementing the method 200 of the embodiments of the present disclosure) and data to be processed (for example, the memory may store configuration files of other modules, etc.). The processor 502 may also access the program instructions and data stored in the memory 504, and execute the program instructions to operate on the data to be processed. The memory 504 may include a volatile storage or a non-volatile storage. In some embodiments, the memory 504 may include a random access memory (RAM), a read-only memory (ROM), an optical disc, a magnetic disk, a hard disk, a solid state disk (SSD), a flash memory, a memory stick, etc.

The network interface 506 may be configured to provide communication with other external devices to the computer device 500 via the network. The network may be any wired or wireless network capable of transmitting and receiving data. For example, the network may be a wired network, a local wireless network (such as Bluetooth, WiFi, near field communication (NFC), etc.), a cellular network, the Internet, or a combination thereof. It can be understood that the type of the network is not limited to the above specific examples.

The peripheral interface 508 may be configured to connect the computer device 500 with one or more peripheral devices to implement information input and output. For example, the peripheral devices may include input devices such as a keyboard, a mouse, a touchpad, a touchscreen, a microphone, various sensors, etc., and output devices such as a display, a speaker, a vibrator, an indicator light, etc.

The bus 510 may be configured to transmit information between various components (such as the processor 502, the memory 504, the network interface 506, and the peripheral interface 508) of the computer device 500, such as an internal bus (such as a processor-memory bus), an external bus (USB port, PCI-E bus), etc.

It should be noted that although the architecture of the above computer device 500 only shows the processor 502, the memory 504, the network interface 506, the peripheral interface 508, and the bus 510, in a specific implementation process, the architecture of the computer device 500 may also include other components necessary for normal operation. In addition, those skilled in the art can understand that the architecture of the above computer device 500 may also only include components necessary for implementing the solutions of the embodiments of the present disclosure, without necessarily including all components shown in the figure.

Based on the same inventive concept, corresponding to any of the above embodiments of the method, the present disclosure further provides a non-transitory computer-readable storage medium, the non-transitory computer-readable storage medium stores computer instructions, and the computer instructions are used to cause the computer to perform the method 200 according to any of the above embodiments.

The computer-readable medium in this embodiment includes permanent and non-permanent, removable and non-removable media, which may be implemented by any method or technology for information storage. The information may be computer-readable instructions, data structures, program modules, or other data. Examples of computer storage media include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM, DVD or other optical storage, magnetic cassette, magnetic tape magnetic disk storage or other magnetic storage devices or any other non-transmission medium, which may be used to store information accessible to the computing device.

The computer instructions stored in the storage medium of the above embodiment are used to cause the computer to perform the method 200 according to any of the above embodiments, and have beneficial effects of the corresponding method embodiments, which will not be repeated here.

Based on the same inventive concept, corresponding to any of the above embodiments of the method 200, the present disclosure further provides a computer program product, which includes a computer program. In some embodiments, the computer program is executable by one or more processors to cause the processors to perform the method 200. Corresponding to the execution body corresponding to each step in each embodiment of the method 200, the processor that executes the corresponding step may belong to the corresponding execution body.

The computer program product of the above embodiment is used to cause the processor to perform the method 200 according to any of the above embodiments, and has beneficial effects of the corresponding method embodiments, which will not be repeated here.

It should be understood by those of ordinary skill in the art that the discussion of any of the above embodiments is merely exemplary, and is not intended to imply that the scope of the present disclosure (including the claims) is limited to these examples. Under the idea of the present disclosure, the technical features in the above embodiments or different embodiments may also be combined, and steps may be implemented in any order, and there are many other variations in different aspects of the embodiments of the present disclosure as described above, which are not provided in detail for the sake of brevity.

In addition, in order to simplify the description and discussion, and not to make the embodiments of the present disclosure difficult to understand, the well-known power/ground connections of the integrated circuit (IC) chip and other components may or may not be shown in the drawings provided. In addition, the apparatus may be shown in the form of a block diagram to avoid making the embodiments of the present disclosure difficult to understand, and this also takes into account the fact that the details of the implementations of these block diagram apparatuses are highly dependent on the platform on which the embodiments of the present disclosure are to be implemented (that is, these details should be completely within the understanding of those skilled in the art). In the case where specific details (such as circuits) are set forth to describe the exemplary embodiments of the present disclosure, it is obvious to those skilled in the art that the embodiments of the present disclosure may be implemented without these specific details or with changes to these specific details. Therefore, these descriptions should be considered as illustrative and not limiting.

Although the present disclosure has been described in conjunction with specific embodiments of the present disclosure, many alternatives, modifications, and variations of these embodiments will be apparent to those of ordinary skill in the art from the foregoing description. For example, other memory architectures (such as dynamic RAM (DRAM)) may use the discussed embodiments.

The embodiments of the present disclosure are intended to cover all such alternatives, modifications, and variations that fall within the broad scope of the appended claims. Therefore, any omission, modification, equivalent replacement, improvement, etc. made within the spirit and principle of the embodiments of the present disclosure shall be included in the protection scope of the present disclosure.

I/We claim:

1. A data query method, comprising:
receiving a query request for target data, the query request being used to request to query the target data in a target database;
matching the query request with a plurality of candidate query categories;
in response to the query request matching a target query category in the plurality of candidate query categories, determining at least one target database parameter of the target database, according to the target query category;
adjusting at least one database parameter of the target database, based on the at least one target database parameter; and
querying the target data in the target database after parameter adjustment, based on the query request.

2. The method according to claim 1, further comprising:
in response to the query request not matching each of the plurality of candidate query categories, querying the target data in the target database, based on the query request.

3. The method according to claim 1, further comprising:
acquiring a plurality of failed query requests;
converting the plurality of failed query requests into a plurality of feature vectors;
obtaining the plurality of candidate query categories by clustering the plurality of feature vectors; and
determining at least one database parameter corresponding to each of the plurality of candidate query categories.

4. The method according to claim 3, wherein determining the at least one database parameter corresponding to each of the plurality of candidate query categories comprises:
determining a plurality of candidate database parameters;
constructing a Markov decision process problem independent of a state, based on the plurality of candidate database parameters, for each of the plurality of candidate query categories; and
solving the Markov decision process problem independent of the state, based on a combinatorial upper confidence bound algorithm, to obtain the at least one database parameter corresponding to the query category.

5. The method according to claim 4, wherein solving the Markov decision process problem independent of the state, based on the combinatorial upper confidence bound algorithm, to obtain the at least one database parameter corresponding to the query category, comprises:
acquiring a plurality of query instances; and
solving the Markov decision process problem independent of the state, based on the combinatorial upper confidence bound algorithm and using the plurality of query instances, to obtain the at least one database parameter corresponding to the query category.

6. The method according to claim 3, wherein matching the query request with the plurality of candidate query categories comprises:
converting the query request into a target feature vector;
calculating distances from the target feature vector to cluster centers corresponding to the plurality of candidate query categories respectively; and
in response to determining that a distance from the target feature vector to a cluster center corresponding to a first query category in the plurality of candidate query categories is less than a distance threshold, determining that a target query category matching the query request is the first query category.

7. The method according to claim 6, wherein matching the query request with the plurality of candidate query categories further comprises:
in response to determining that each distance from the target feature vector to each cluster center corresponding to each of the plurality of candidate query categories is not less than the distance threshold, determining that the query request does not match each of the plurality of candidate query categories.

8. The method according to claim 1, wherein the candidate query category indicates at least one of the following:
at least one database parameter corresponding to a query request matching the candidate query category being adjustable; and
a query success rate of a query request matching the candidate query category being lower than a success rate threshold.

9. The method according to claim 1, wherein the at least one target database parameter comprises a hardware parameter of the target database.

10. A computer device, comprising one or more processors, a memory, and one or more programs, wherein the one or more programs are stored in the memory and executed by the one or more processors, and the one or more programs comprise instructions which, when executed by the one or more processors, cause the one or more processors to:
receive a query request for target data, the query request being used to request to query the target data in a target database;
match the query request with a plurality of candidate query categories;
in response to the query request matching a target query category in the plurality of candidate query categories, determine at least one target database parameter of the target database, according to the target query category;
adjust at least one database parameter of the target database, based on the at least one target database parameter; and
query the target data in the target database after parameter adjustment, based on the query request.

11. The computer device according to claim 10, wherein the instructions further cause the one or more processors to:
in response to the query request not matching each of the plurality of candidate query categories, query the target data in the target database, based on the query request.

12. The computer device according to claim 10, wherein the instructions further cause the one or more processors to:
acquire a plurality of failed query requests;
convert the plurality of failed query requests into a plurality of feature vectors;
obtain the plurality of candidate query categories by clustering the plurality of feature vectors; and
determine at least one database parameter corresponding to each of the plurality of candidate query categories.

13. The computer device according to claim 12, wherein the instructions further cause the one or more processors to:
determine a plurality of candidate database parameters;
construct a Markov decision process problem independent of a state, based on the plurality of candidate database parameters, for each of the plurality of candidate query categories; and
solve the Markov decision process problem independent of the state, based on a combinatorial upper confidence bound algorithm, to obtain the at least one database parameter corresponding to the query category.

14. The computer device according to claim 13, wherein the instructions further cause the one or more processors to:
acquire a plurality of query instances; and
solve the Markov decision process problem independent of the state, based on the combinatorial upper confidence bound algorithm and using the plurality of query instances, to obtain the at least one database parameter corresponding to the query category.

15. The computer device according to claim 12, wherein the instructions further cause the one or more processors to:
convert the query request into a target feature vector;
calculate distances from the target feature vector to cluster centers corresponding to the plurality of candidate query categories respectively; and
in response to determining that a distance from the target feature vector to a cluster center corresponding to a first query category in the plurality of candidate query categories is less than a distance threshold, determine that a target query category matching the query request is the first query category.

16. The computer device according to claim 15, wherein the instructions further cause the one or more processors to:
in response to determining that each distance from the target feature vector to each cluster center corresponding to each of the plurality of candidate query categories is not less than the distance threshold, determine that the query request does not match each of the plurality of candidate query categories.

17. The computer device according to claim 10, wherein the candidate query category indicates at least one of the following:
at least one database parameter corresponding to a query request matching the candidate query category being adjustable; and
a query success rate of a query request matching the candidate query category being lower than a success rate threshold.

18. The computer device according to claim 10, wherein the at least one target database parameter comprises a hardware parameter of the target database.

19. A non-transitory computer-readable storage medium comprising a computer program, wherein the computer program, when executed by one or more processors, causes the one or more processors to:
receive a query request for target data, the query request being used to request to query the target data in a target database;
match the query request with a plurality of candidate query categories;
in response to the query request matching a target query category in the plurality of candidate query categories, determine at least one target database parameter of the target database, according to the target query category;
adjust at least one database parameter of the target database, based on the at least one target database parameter; and
query the target data in the target database after parameter adjustment, based on the query request.

20. The non-transitory computer-readable storage medium according to claim 19, wherein the computer program further causes the one or more processors to:
in response to the query request not matching each of the plurality of candidate query categories, query the target data in the target database, based on the query request.
